(19) United States
(12) Patent Application Publication
(10) Pub. No.: US 2026/0186278 A1
(43) Pub. Date: Jul. 2, 2026

(54) REAR CONVERTER LENS, LENS APPARATUS, AND IMAGE PICKUP APPARATUS

(71) Applicant: CANON KABUSHIKI KAISHA, Tokyo (JP)

(72) Inventor: Akihiko YUKI, Saitama (JP)

(21) Appl. No.: 19/432,422

(22) Filed: Dec. 24, 2025

(30) Foreign Application Priority Data
Dec. 27, 2024 (JP) 2024-232055

(51) Int. Cl. G02B 15/10

(52) U.S. Cl. CPC G02B 15/10

(57) ABSTRACT

A rear converter lens disposed on an image side of a main lens, including a first positive lens, a second positive lens, and a first negative lens, in which anomalous dispersion properties with respect to the C-line and the t-line of materials forming the first positive lens, the second positive lens, and the first negative lens and a ratio of a combined focal length of the main lens and the rear converter lens to a focal length of the main lens are appropriately set where the anomalous dispersion property is defined by a partial dispersion ratio with respect to the C-line and the t-line and an Abbe number with respect to the d-line.

### BACKGROUND

### Field of the Technology

The disclosure relates to a rear converter lens, a lens apparatus, and an image pickup apparatus.

### Description of the Related Art

Conventionally, a rear converter lens which is disposed on an image side of a main lens and which adds various functions has been proposed. (Japanese Patent Laid-Open No. 2004-226648 and Japanese Patent Laid-Open No. H09-33806)

Conventionally, a zoom lens optimized for visible light has a problem in that correction of chromatic aberration in a near-infrared region other than visible light is insufficient. In order to solve such a problem, it is considered that chromatic aberration in the near-infrared region of the main lens is corrected by the rear converter lens. The rear converter lenses disclosed in Japanese Patent Laid-Open No. 2004-226648 and Japanese Patent Laid-Open No. H09-33806 are sufficient for correcting chromatic aberration of near-infrared light from visible light generated by the rear converter lens itself but are insufficient for correcting chromatic aberration of near-infrared light of the main lens.

### SUMMARY

It is desirable to provide a rear converter lens that sufficiently corrects chromatic aberration of near-infrared light of a main lens.

According to an aspect of the disclosure, there is provided a rear converter lens disposed on an image side of a main lens, comprising a first positive lens, a second positive lens, and a first negative lens, in which the following inequalities are satisfied,

$$- 0.2 \leq Δθct\_p1 \leq - 0 \text{.02}$$

$$- 0.2 \leq Δθct\_p2 \leq - 0.02$$

$$0.017 \leq Δθct\_n1 \leq 0.05$$

where Δθct_p1, Δθct_p2 and Δθct_n1 represent anomalous dispersion properties with respect to the C-line and the t-line of the first positive lens, the second positive lens and the first negative lens, respectively, and the anomalous dispersion property with respect to the C-line and the t-line Δθct is defined as

$$Δθ ct = θ ct - ( 0.0046925 \times v d + 0.5466489 )$$

where θct represents a partial dispersion ratio with respect to the C-line and the t-line and vd represents an Abbe number with respect to the d-line, and
in which the following inequality is satisfied,

$$0.6 \leq β \leq 2.2$$

where β represents a ratio of a combined focal length of the main lens and the rear converter lens to a focal length of the main lens.

According to another aspect of the disclosure, there is provided a rear converter lens disposed on an image side of a main lens, comprising a positive lens and a negative lens,
in which the following inequalities are satisfied,

$$- 0.2 \leq Δθct\_p1 \leq - 0 \text{.02}$$

$$0.017 \leq Δθct\_n1 \leq 0.05$$

where Δθct_p1 and Δθct_n1 represent anomalous dispersion properties with respect to the C-line and the t-line of the positive lens and the negative lens, respectively, and the anomalous dispersion property with respect to the C-line and the t-line Δθct is defined as

$$Δθ ct = θ ct - ( 0.0046925 \times v d + 0.5466489 )$$

where θct represents a partial dispersion ratio with respect to the C-line and the t-line and vd represents an Abbe number with respect to the d-line, and
in which the following inequality is satisfied,

$$0.6 \leq β \leq 2.2$$

where β represents a ratio of a combined focal length of the main lens and the rear converter lens to a focal length of the main lens.

Features of the disclosure will become apparent from the following description of embodiments with reference to the attached drawings. The following description of embodiments is described by way of example.

### BRIEF DESCRIPTION OF THE DRAWINGS

FIG. 1 is a cross-sectional view of a case where a rear converter lens of Embodiment 1 is attached to a main lens when focusing on infinity at a wide angle end.

FIG. 2 is a longitudinal aberration diagram when focusing on infinity at the wide angle end in a case where the rear converter lens of Embodiment 1 is attached to the main lens.

FIG. 3 is a lens cross-sectional view when focusing on infinity at the wide-angle end in a case where the rear converter lens of Embodiment 2 is attached to the main lens.

FIG. 4 is a longitudinal aberration diagram when focusing on infinity at the wide angle end in a case where the rear converter lens of Embodiment 2 is attached to the main lens.

FIG. 5 is a lens cross-sectional view when focusing on infinity at the wide-angle end in a case where the rear converter lens of Embodiment 3 is attached to the main lens.

FIG. 6 is a longitudinal aberration diagram when focusing on infinity at the wide angle end in a case where the rear converter lens of Embodiment 3 is attached to the main lens.

FIG. 7 is a lens cross-sectional view when focusing on infinity at the wide-angle end in a case where the rear converter lens of Embodiment 4 is attached to the main lens.

FIG. 8 is a longitudinal aberration diagram when focusing on infinity at the wide angle end in a case where the rear converter lens of Embodiment 4 is attached to the main lens.

FIG. 9 is a lens cross-sectional view when focusing on infinity at the wide-angle end in a case where the rear converter lens of Embodiment 5 is attached to the main lens.

FIG. 10 is a longitudinal aberration diagram when focusing on infinity at the wide angle end in a case where the rear converter lens of Embodiment 5 is attached to the main lens.

FIG. 11 is a lens cross-sectional view when focusing on infinity at the wide-angle end in a case where the rear converter lens of Embodiment 6 is attached to the main lens.

FIG. 12 is a longitudinal aberration diagram when focusing on infinity at the wide angle end in the case where the rear converter lens of Embodiment 6 is attached to the main lens.

FIG. 13 is a schematic diagram of a main part of an image pickup apparatus according to an embodiment of the disclosure.

### DESCRIPTION OF THE EMBODIMENTS

Hereinafter, preferred embodiments of the disclosure will be described. Each of the embodiments of the present invention described below can be implemented solely or as a combination of a plurality of the embodiments or features thereof where necessary or where the combination of elements or features from individual embodiments in a single embodiment is beneficial.

A rear converter lens Gr according to the embodiments is disposed on an image side of a main lens Gm, and includes a first positive lens Lp1, a second positive lens Lp2, and a first negative lens Ln1. The rear converter lens Gr satisfies the following inequalities,

$$- 0.20 \leq Δθct\_p1 \leq - 0 \text{.02} \qquad ( 1 )$$

$$- 0.2 \leq Δθct\_p2 \leq - 0.02 \qquad ( 2 )$$

$$0.017 \leq Δθct\_n1 \leq 0.05 \qquad ( 3 )$$

where Δθct_p1, Δθct_p2 and Δθct_n1 represent anomalous dispersion properties with respect to the C-line and the t-line of the first positive lens Lp1, the second positive lens Lp2, and the first negative lens Ln1, respectively.

Note that the anomalous dispersion property Act of the material with respect to the C-line and the t-line is expressed by the following equation,

$$Δθ ct = θ ct - ( 0.0046925 \times v d + 0.5466489 )$$

where θct represents a partial dispersion ratio of the material with respect to the C-line and the t-line and vd represents an Abbe number with respect to the d-line, and where the Abbe number vd and the partial dispersion ratio θct are respectively represented by the following equations,

$$v d = ( Nd - 1 ) / ( NF - NC )$$

$$θ ct - ( NC - Nt ) / ( NF - NC ) .$$

where Nd, NC, NF, and Nt represent refractive indices of an optical material at the d-line, the C-line, the F-line, and the t-line, respectively.

As described above, the rear converter lens Gr according to the embodiments includes the first positive lens Lp1, the second positive lens Lp2, and the first negative lens Ln1 which are made of materials having appropriate anomalous dispersion properties with respect to the C-line and the t-line. Thus, the rear converter lens Gr capable of correcting the chromatic aberration in the near-infrared light of the main lens Gm is realized.

In general, in the main lens Gm specialized for correcting chromatic aberration in the visible light, axial chromatic aberration in the near-infrared light remains in the over direction (direction away from an object) at a reference wavelength (d-line).

In the disclosure, by applying a material having a relatively high refractive index at the near-infrared light relative to visible light to at least two positive lenses (the first positive lens Lp1 and the second positive lens Lp2) of the rear converter lens Gr, axial chromatic aberration in the over direction of the main lens Gm is corrected. Specifically, the first positive lens Lp1 and the second positive lens Lp2 are made of materials having large anomalous dispersion properties with respect to the C-line and the t-line in the negative direction.

Further, in the disclosure, at least one negative lens (first negative lens Ln1) of the rear converter lens Gr is made of a material having a relatively low refractive index at the near-infrared light relative to the visible light. Accordingly, the occurrence of axial chromatic aberration in the over direction in the near-infrared light remaining in the chromatic correction in the visible light of the rear converter lens Gr is suppressed. Specifically, the first negative lens Ln1 is made of a material having a large anomalous dispersion property with respect to the C-line and the t-line in the positive direction.

If the upper limit of the inequality (1) or the inequality (2) is not satisfied, the anomalous dispersion property of the materials of the first positive lens Lp1 and the second positive lens Lp2 becomes too large in the positive direction, and the effect of correcting the axial chromatic aberration in the near-infrared light becomes too small. If the lower limit of the inequality (1) or the inequality (2) is not satisfied, a material whose refractive index at the reference wavelength (d-line) is too low is selected for the first positive lens Lp1 and the second positive lens Lp2, and it is difficult to satisfactorily correct spherical aberration.

If the upper limit of the inequality (3) is not satisfied, a material having an Abbe number, which has excessively low dispersion, of the first negative lens Ln1 is selected, which makes it difficult to perform achromatism in the first order in the visible light. If the lower limit of the inequality (3) is not satisfied, the anomalous dispersion property of the first negative lens Ln1 becomes too large in the negative direction, and it becomes difficult to suppress the axial chromatic aberration in the over direction in the near-infrared light.

More preferably, the inequalities (1) to (3) are set as follows.

$$- 0.18 \leq Δθct\_p1 \leq - 0 \text{.03} \qquad ( 1 a )$$

$$- 0.1 \; 8 \leq Δθct\_p2 \leq - 0.03 \qquad ( 2 a )$$

$$0.018 \leq Δθct\_n \leq 0.04 \qquad ( 3 a )$$

More preferably, the inequalities (1a) to (3a) are set as follows.

$$- 0.17 \leq Δθct\_p1 \leq - 0 \text{.04} \qquad ( 1 b )$$

$$- 0.1 \; 7 \leq Δθct\_p2 \leq - 0 \text{.04} \qquad ( 2 b )$$

$$0.0182 \leq Δθct\_n \leq 0.036 \qquad ( 3 b )$$

As a more desirable aspect of the disclosure, the following inequalities (4) and (5) are satisfied,

$$50 \leq vp 1 \leq 100 \qquad ( 4 )$$

$$50 \leq vp 2 \leq 100 \qquad ( 5 )$$

where vp1 and vp2 represent Abbe numbers of the first positive lens Lp1 and the second positive lens Lp2 with respect to the d-line, respectively.

If the upper limit of the inequality (4) or the inequality (5) is not satisfied, the material of the first positive lens Lp1 and/or the second positive lens Lp2 is a material of excessively high dispersion, and it becomes difficult to correct the axial chromatic aberration in the visible light. If the lower limit of the inequality (4) or the inequality (5) is not satisfied, a material having a too low refractive index at the reference wavelength (d-line) is selected for the first positive lens Lp1 or the second positive lens Lp2, which makes it difficult to satisfactorily correct spherical aberration.

As a more desirable aspect of the disclosure, the following inequality (6) is satisfied,

$$30 \leq vn 1 \leq 80 \qquad ( 6 )$$

where vn1 represents an Abbe number of the first negative lens Ln1 with respect to the d-line.

If the upper limit of the inequality (6) is not satisfied, the material of the first negative lens Ln1 is a material having an Abbe number with dispersion being too low, and it becomes difficult to perform primary achromatization of the visible light. If the lower limit of the inequality (6) is not satisfied, the material of the first negative lens Ln1 is a material having an Abbe number with a dispersion being too high, and it becomes difficult to correct the secondary spectrum of the visible light.

As a more desirable aspect of the disclosure, the rear converter lens Gr includes a second negative lens Ln2 in addition to the first negative lens Ln1, and the following inequality (7) is satisfied,

$$0.017 \leq Δθct\_n2 \leq 0.05 \qquad ( 7 )$$

where Δθct_n2 represents the anomalous dispersion property with respect to the C-line and the t-line of the second negative lens Ln2.

If the upper limit of the inequality (7) is not satisfied, a material of an Abbe number having excessively low dispersion is selected for the second negative lens Ln2, and it is difficult to perform first-order achromatization of the visible light. If the lower limit of the inequality (7) is not satisfied, the anomalous dispersion property of the second negative lens Ln2 becomes too large in the negative direction, and it becomes difficult to suppress the axial chromatic aberration at the near-infrared light in the over direction.

As a more desirable aspect of the disclosure, the following inequality (8) is satisfied,

$$0.02 \leq fp 1 / \vert f \vert \leq 0.8 \qquad ( 8 )$$

where fp1 represents the focal length of the first positive lens Lp1 and f represents the focal length of the rear converter lens Gr.

If the upper limit of the inequality (8) is not satisfied, the refractive power of the first positive lens Lp1 is too weak, and the effect of correcting the axial chromatic aberration at the near-infrared light becomes too small. If the lower limit of the inequality (8) is not satisfied, the refractive power of the first positive lens Lp1 is too weak, and it is difficult to satisfactorily correct the spherical aberration. As a more desirable aspect of the disclosure, the following inequality (9) is satisfied,

$$0.05 \leq fp 2 / \vert f \vert \leq 1.2 \qquad ( 9 )$$

where fp2 represents the focal length of the second positive lens Lp2 and f represents the focal length of the rear converter lens Gr.

If the upper limit of the inequality (9) is not satisfied, the refractive power of the second positive lens Lp2 is too weak, and the effect of correcting the axial chromatic aberration at the near-infrared light becomes too small. If the lower limit of the inequality (9) is not satisfied, the refractive power of the second positive lens Lp2 is too weak, and it is difficult to satisfactorily correct the spherical aberration.

As a more desirable aspect of the disclosure, the following inequality (10) is satisfied,

$$- 0.9 \leq fn 1 / \vert f \vert \leq - 0.02 \qquad ( 10 )$$

where fn1 represents the focal length of the first negative lens Ln1 and f represents the focal length of the rear converter lens Gr.

If the upper limit of the inequality (10) is not satisfied, the refractive power of the first negative lens Ln1 is too strong, and it is difficult to suppress the axial chromatic aberration at the near-infrared light in the over direction. If the lower limit of the inequality (10) is not satisfied, the refractive power of the first negative lens Ln1 is too weak, and it is difficult to perform the first-order achromatization at the visible light.

As a more desirable aspect of the disclosure, the rear converter lens Gr includes a third positive lens Lp3, and the following inequalities (11) and (12) are satisfied,

$$- 0.20 \leq Δθct\_p3 \leq - 0 \text{.02} \qquad ( 11 )$$

$$1.6 \leq Np 3 \leq 1.8 \qquad ( 12 )$$

where Δθct_p3 represents an anomalous dispersion property with respect to the C-line and the t-line of the material of the third positive lens Lp3 and Np3 represents a refractive index at the d-line of the third positive lens Lp3.

If the upper limit of the inequality (11) is not satisfied, the anomalous dispersion property of the material of the third positive lens Lp3 becomes too large in the positive direction, and the effect of correcting the axial chromatic aberration at the near-infrared light becomes too small. If the lower limit of the inequality (11) is not satisfied, a material having a low refractive index at the reference wavelength (d-line) is selected for the third positive lens Lp3, which makes it difficult to satisfactorily correct the spherical aberration.

If the upper limit of inequality (12) is not satisfied, the material of the third positive lens Lp3 is a material with a dispersion being too high, and it becomes difficult to correct the axial chromatic aberration at the visible light. If the lower limit of the inequality (12) is not satisfied, a material having a low refractive index at the reference wavelength (d-line) is selected for the third positive lens Lp3, which makes it difficult to satisfactorily correct the spherical aberration.

As a more desirable aspect of the disclosure, the following inequality (13) is satisfied,

$$0.6 \leq β \leq 2.2 \qquad ( 13 )$$

where β represents a ratio of a combined focal length of the main lens Gm and the rear converter lens Gr to the focal length of the main lens Gm ((the combined focal length of the main lens Gm and the rear converter lens Gr)/(the focal length of the main lens Gm)).

If the upper limit of the inequality (13) is not satisfied, the magnification of the rear converter lens Gr becomes too large, and it becomes difficult to correct the chromatic aberration at the near-infrared light of the main lens Gm. If the lower limit of the inequality (13) is not satisfied, the positive refractive power of the rear converter lens Gr becomes too strong, and it becomes difficult to satisfactorily correct the spherical aberration.

As a more desirable aspect of the disclosure, the numerical ranges of the inequalities (4) to (13) may be set as follows.

$$60 \leq vp 1 \leq 98 \qquad ( 4 a )$$

$$60 \leq vp 2 \leq 98 \qquad ( 5 a )$$

$$32 \leq vn 1 \leq 70 \qquad ( 6 a )$$

$$0.018 \leq Δθct\_n2 \leq 0.04 \qquad ( 7 a )$$

$$0.03 \leq fp 1 / \vert f \vert \leq 0.75 \qquad ( 8 a )$$

$$0.06 \leq fp 2 / \vert f \vert \leq 1.15 \qquad ( 9 a )$$

$$- 0.8 \; 8 \leq fn 1 / \vert f \vert \leq - 0.03 \qquad ( 10 a )$$

$$- 0.1 \leq Δθct\_p3 \leq - 0.0 \; 25 \qquad ( 11 a )$$

$$1.67 \leq N d 3 \leq 1.78 \qquad ( 12 a )$$

$$0.67 \leq β \leq 2.1 \qquad ( 13 a )$$

Hereinafter, embodiments according to the disclosure will be described with reference to the drawings.

First, a main lens Gm having a common configuration to which a rear converter lens Gr of each embodiment described later is applied will be described.

### (Main Lens Gm)

The main lens Gm is composed of, in order from the object side to the image side, a first lens unit L1 having a positive refractive power, a second lens unit L2 having a negative refractive power, a third lens unit L3 having a negative refractive power, a fourth lens unit L4 having a positive refractive power, and a fifth lens unit L5 having a positive refractive power. The interval between the lens units adjacent to each other changes during zooming.

During zooming from the wide angle end to the telephoto end, the second lens unit L2 moves toward the image side, and the third lens unit L3 and the fourth lens unit L4 move along different loci convex toward the object side. The first lens unit L1 and the fifth lens unit L5 do not move for zooming.

The first lens unit L1 includes a first surface to an eleventh surface from the object side, and fifth and sixth lenses corresponding to the eighth surface to the eleventh surface move along the optical axis during focusing. The second lens unit L2 includes a twelfth surface to an eighteenth surface from the object side. The third lens unit L3 includes a nineteenth surface to a twenty-third surface from the object side. The fourth lens unit L4 includes a twenty-fourth surface to a twenty-seventh surface from the object side. The twenty-eighth surface corresponds to an aperture stop and does not move for zooming. The fifth lens unit L5 includes a twenty-nineth surface to a forty-first surface from the object side.

An image plane I corresponds to an image pickup plane of a solid-state image pickup element (photoelectric conversion element) or the like that receives and photoelectrically converts an image formed by the main lens Gm and the rear converter lens Gr when used as an image pickup optical system of a monitoring camera or a video camera.

Next, features of the rear converter lens Gr of each example will be described.

### Embodiment 1

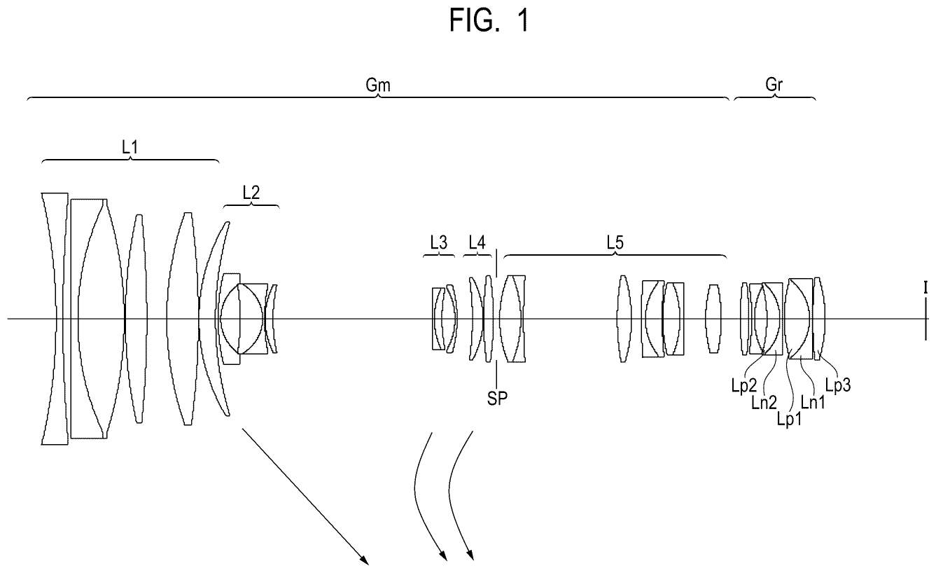

FIG. 1 is a diagram illustrating a configuration of an entire optical system in a state in which a rear converter lens Gr according to Embodiment 1 is disposed in a main lens Gm when focusing on infinity at the wide angle end.

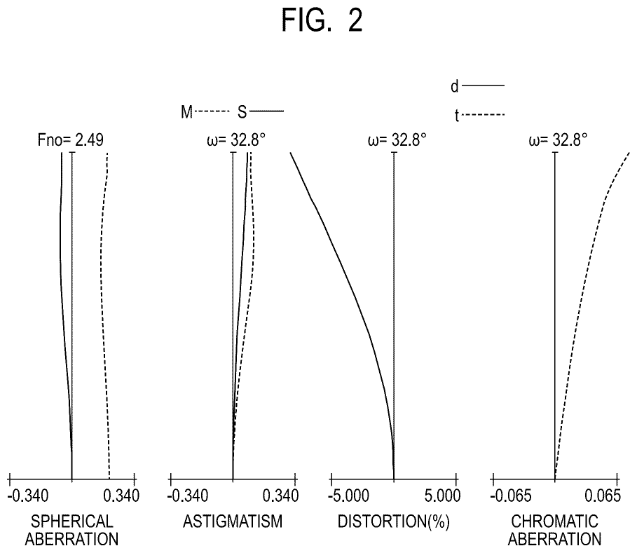

FIG. 2 is a longitudinal aberration diagram of a state in which the rear converter lens Gr according to Embodiment 1 is disposed in the main lens Gm when focusing on infinity at the wide angle end. In the longitudinal aberration diagram, a solid line and a broken line in the spherical aberration diagram indicate the d-line and the t-line, respectively. A broken line and a solid line in astigmatism indicate a meridional image plane and a sagittal image plane, respectively, and a one-dot chain line in chromatic aberration of magnification indicates a t-line. ω is a half angle of view, and Fno is an F number. In the longitudinal aberration diagram, the spherical aberration, the astigmatism, the distortion, and the lateral chromatic aberration are drawn on scales of 0.34 mm, 0.34 mm, 5%, and 0.065 mm, respectively.

The rear converter lens Gr according to Embodiment 1 is disposed on the image side of the main lens Gm, thereby enlarging the focal length of the main lens Gm to 1.3 times. The rear converter lens Gr according to Embodiment 1 includes six lenses, i.e., a negative lens, a cemented lens formed by cementing the second positive lens Lp2 and the second negative lens Ln2, a cemented lens formed by cementing the first positive lens Lp1 and the first negative lens Ln1, and the third positive lens Lp3, in order from the object side to the image side along the optical axis.

By configuring the rear converter lens Gr with three positive lenses and three negative lenses, it is advantageous in correcting the spherical aberration and the curvature of field at the visible light. Further, by including a lens in which a material having an anomalous dispersion property of the partial dispersion ratio with respect to the C-line and the t-line is applied to these lenses, the effect of correcting the chromatic aberration at the near-infrared light of the main lens Gm by the rear converter lens Gr is achieved.

As shown in the aberration diagram of FIG. 2, the rear converter lens Gr of Embodiment 1 satisfactorily corrects each aberration. As shown in Table 1, the rear converter lens Gr of Embodiment 1 satisfies the inequalities (1) to (13) and realizes a rear converter lens that sufficiently corrects the chromatic aberration at the near-infrared light of the main lens Gm.

### Embodiment 2

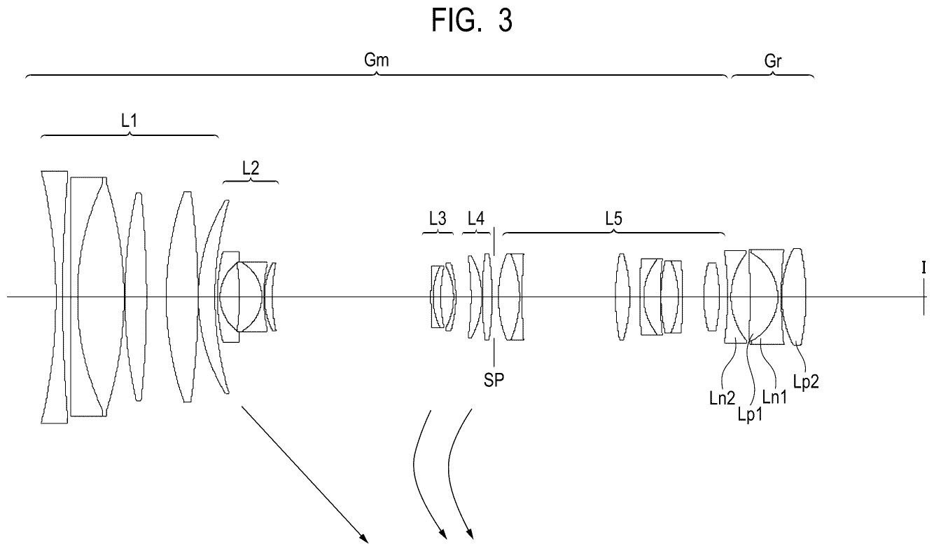

FIG. 3 is a diagram illustrating a configuration of an entire optical system in a state in which a rear converter lens Gr according to Embodiment 2 is disposed in a main lens Gm in a wide-angle end state.

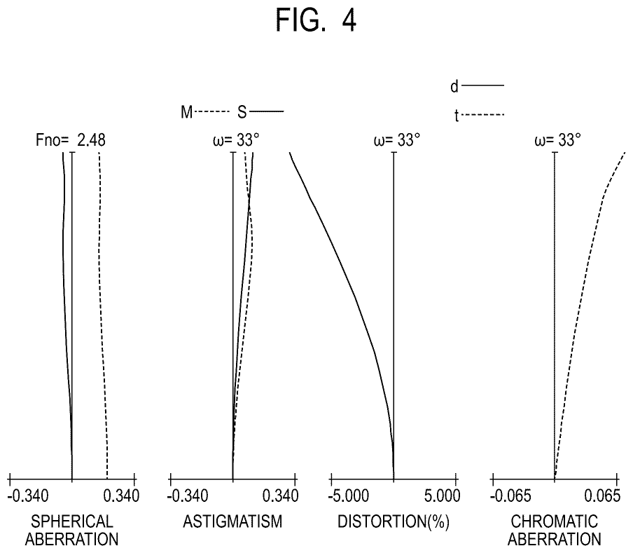

FIG. 4 is a longitudinal aberration diagram when focusing on an object at infinity at the wide angle end in a state where the rear converter lens Gr according to Embodiment 2 is disposed in the main lens Gm. In the longitudinal aberration diagram, a solid line and a broken line in the spherical aberration indicate the d-line and the t-line, respectively. A broken line and a solid line in the astigmatism indicate a meridional image plane and a sagittal image plane, respectively, and a one-dot chain line in the chromatic aberration of magnification indicates the t-line. ω is a half angle of view, and Fno is an F number. In the longitudinal aberration diagram, the spherical aberration, the astigmatism, the distortion, and the lateral chromatic aberration are drawn on scales of 0.34 mm, 0.34 mm, 5%, and 0.065 mm, respectively.

The rear converter lens Gr according to Embodiment 2 is a converter lens that is disposed on the image side of the main lens Gm to increase the focal length of the main lens Gm to 1.3 times.

The rear converter lens Gr includes four lenses, i.e., a second negative lens Ln2, a cemented lens obtained by cementing the first positive lens Lp1 and the first negative lens Ln1, and the second positive lenses Lp2, in order from the object along the optical axis.

By configuring the rear converter lens Gr with two positive lenses and two negative lenses, it is possible to achieve the effect of correcting the chromatic aberration at the near-infrared light of the main lens Gm with the rear converter lens Gr by applying a material having an anomalous dispersion property of the partial dispersion ratio with respect to the C-line and the t-line to those lenses while achieving a configuration advantageous for correcting the spherical aberration at the visible light and the curvature of field.

As shown in the aberration diagram of FIG. 4, the rear converter lens Gr of Embodiment 2 corrects the aberrations preferably. As shown in Table 1, the rear converter lens Gr of Embodiment 2 satisfies the inequalities (1) to (13) and realizes a rear converter lens that sufficiently corrects the chromatic aberration at the near-infrared light of the main lens.

### Embodiment 3

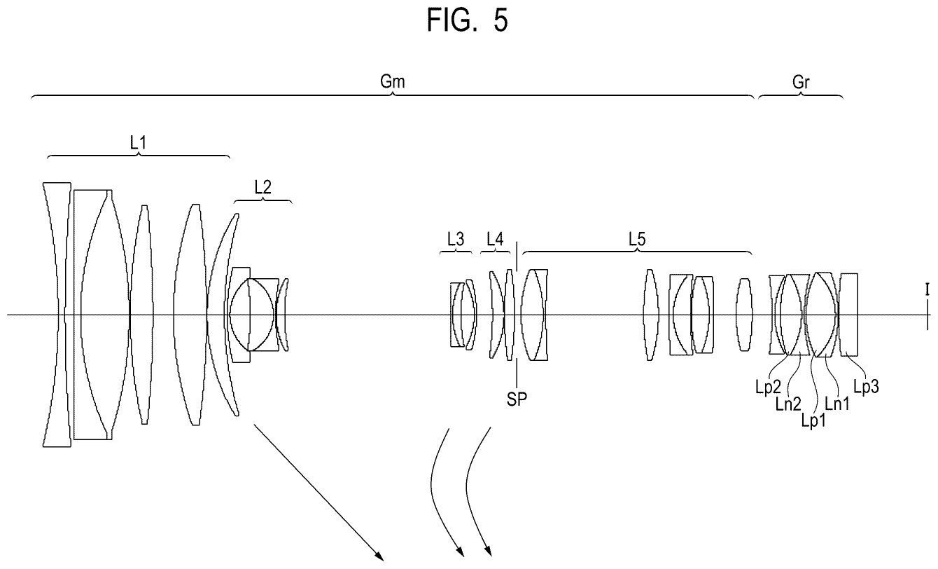

FIG. 5 is a diagram illustrating a configuration of an entire optical system in a state in which the rear converter lens Gr according to Embodiment 3 is disposed in a main lens Gm in a wide-angle end state.

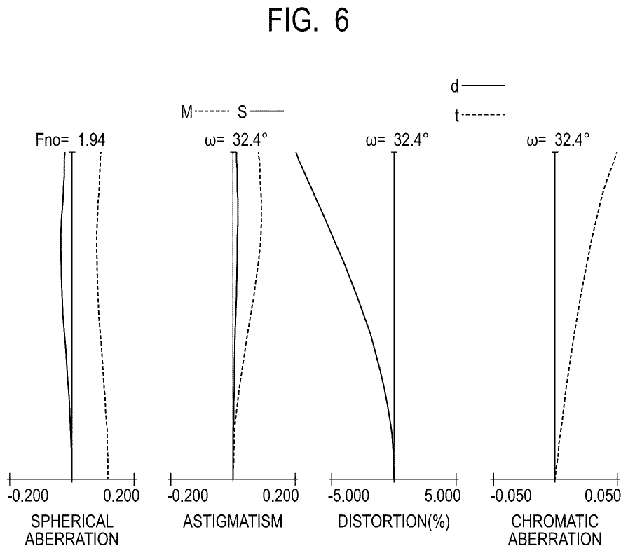

FIG. 6 is a longitudinal aberration diagram when focusing on an object at infinity at the wide angle end in a state where the rear converter lens Gr according to Embodiment 3 is disposed in the main lens Gm. In the longitudinal aberration diagram, a solid line and a broken line in the spherical aberration indicate the d-line and the t-line, respectively. A broken line and a solid line in the astigmatism indicate a meridional image plane and a sagittal image plane, respectively, and a one-dot chain line in the chromatic aberration of magnification indicates the t-line. @ is a half angle of view, and Fno is an F number. In the longitudinal aberration diagram, the spherical aberration, the astigmatism, the distortion, and the lateral chromatic aberration are drawn on scales of 0.2 mm, 0.2 mm, 5%, and 0.050 mm, respectively.

The rear converter lens Gr according to Embodiment 3 is disposed on the image side of the main lens Gm to correct the chromatic aberration at the near-infrared light of the main lens Gm without increasing the focal length of the main lens Gm.

The rear converter lens Gr includes six lenses, i.e., a negative lens, a cemented lens formed by cementing the second positive lens Lp2 and the second negative lens Ln2, a cemented lens formed by cementing the first positive lens Lp1 and the first negative lens Ln1, and the third positive lens Lp3, in order from the object side along the optical axis.

By configuring the rear converter lens Gr with three positive lenses and three negative lenses, it is possible to achieve the effect of correcting the chromatic aberration at the near-infrared light of the main lens Gm with the rear converter lens Gr by applying a material having an anomalous dispersion property of the partial dispersion ratio with respect to the C-line and the t-line to those lenses while achieving a configuration advantageous for correcting the spherical aberration at the visible light and the curvature of field.

As shown in the aberration diagrams of FIG. 6, the rear converter lens Gr of Embodiment 3 satisfactorily corrects each aberration. As shown in Table 1, the rear converter lens Gr of Embodiment 3 satisfies the inequalities (1) to (13) and realizes a rear converter lens that sufficiently corrects the chromatic aberration at the near-infrared light of the main lens.

### Embodiment 4

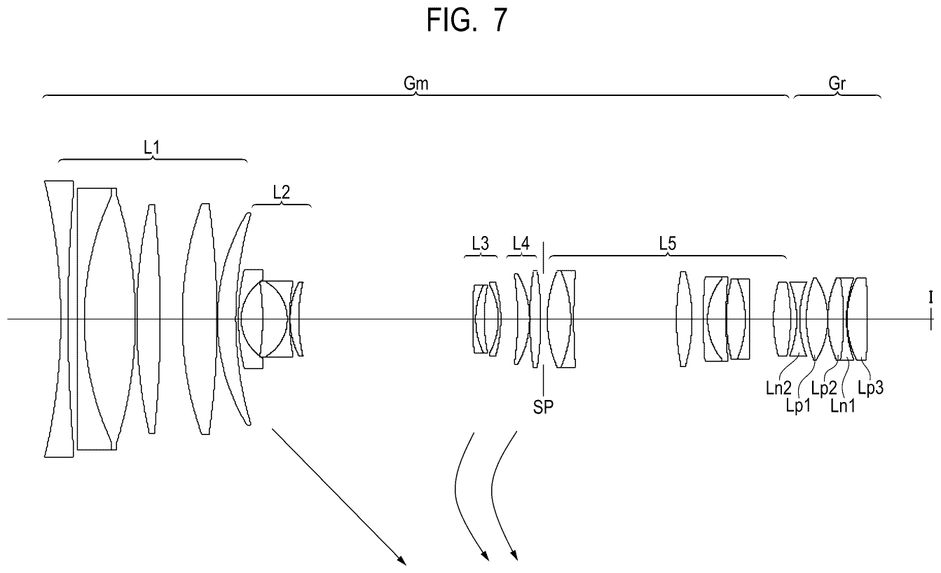

FIG. 7 is a diagram illustrating a configuration of an entire optical system in a state in which a rear converter lens Gr according to Embodiment 4 is disposed in a main lens Gm in a wide-angle end state.

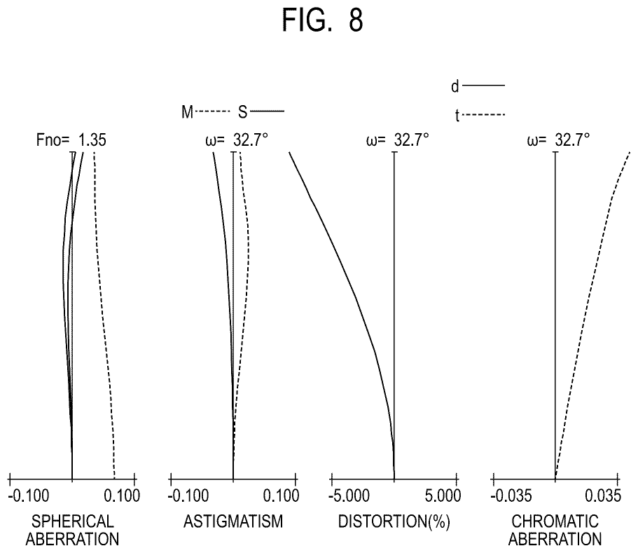

FIG. 8 is a longitudinal aberration diagram when focusing on an object at infinity at the wide angle end in a state where the rear converter lens Gr according to Embodiment 4 is disposed in the main lens Gm. In the longitudinal aberration diagram, a solid line and a broken line in the spherical aberration indicate the d-line and the t-line, respectively. A broken line and a solid line in the astigmatism indicate a meridional image plane and a sagittal image plane, respectively, and a one-dot chain line in the chromatic aberration of magnification indicate the t-line. @ is a half angle of view, and Fno is an F number. In the longitudinal aberration diagram, the spherical aberration, the astigmatism, the distortion, and the lateral chromatic aberration are drawn on scales of 0.1 mm, 0.1 mm, 5%, and 0.035 mm, respectively.

The rear converter lens Gr according to Embodiment 4 is disposed on the image side of the main lens Gm to reduce the focal length of the main lens to 0.7 times.

The rear converter lens Gr includes five lenses, i.e., the second negative lens Ln2, the first positive lens Lp1, a cemented lens obtained by cementing the second positive lens Lp2 and the first negative lens Ln1, and the third positive lens Lp3, in order from the object side along the optical axis.

By configuring the rear converter lens Gr with three positive lenses and two negative lenses, it is possible to achieve the effect of correcting the chromatic aberration at the near-infrared light of the main lens Gm with the rear converter lens Gr by applying a material having an anomalous dispersion property of the partial dispersion ratio with respect to the C-line and the t-line to those lenses while achieving a configuration advantageous for correcting the spherical aberration at the visible light and the curvature of field.

As shown in the aberration diagrams of FIG. 8, the rear converter lens Gr of Embodiment 4 satisfactorily corrects each aberration. As shown in Table 1, the rear converter lens Gr of Numerical Embodiment 4 corresponding to Embodiment 4 satisfies the inequalities (1) to (13) and realizes a rear converter lens that sufficiently corrects the chromatic aberration at the near-infrared light of the main lens.

### Embodiment 5

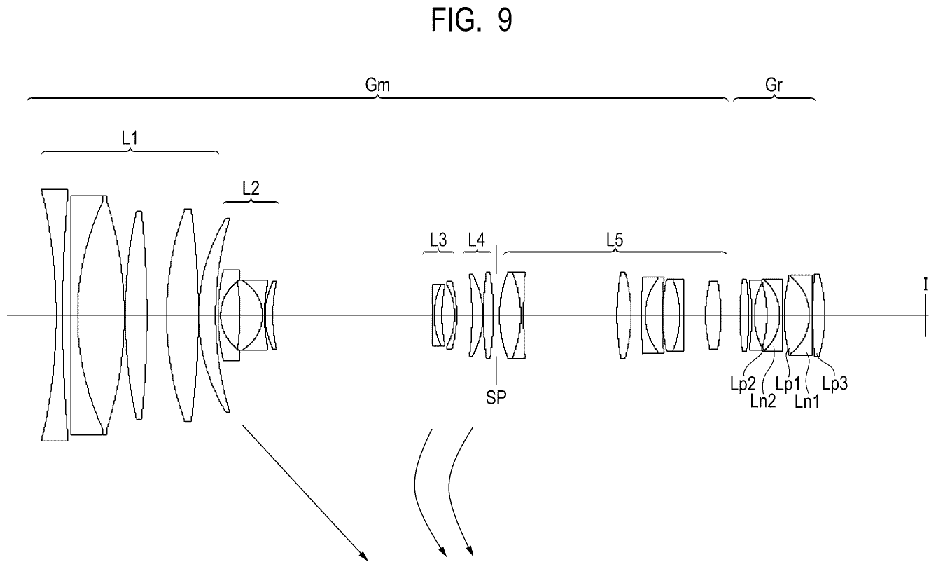

FIG. 9 is a diagram illustrating a configuration of an entire optical system in a state in which a rear converter lens Gr according to Embodiment 5 is disposed in a main lens Gm in a wide-angle end state.

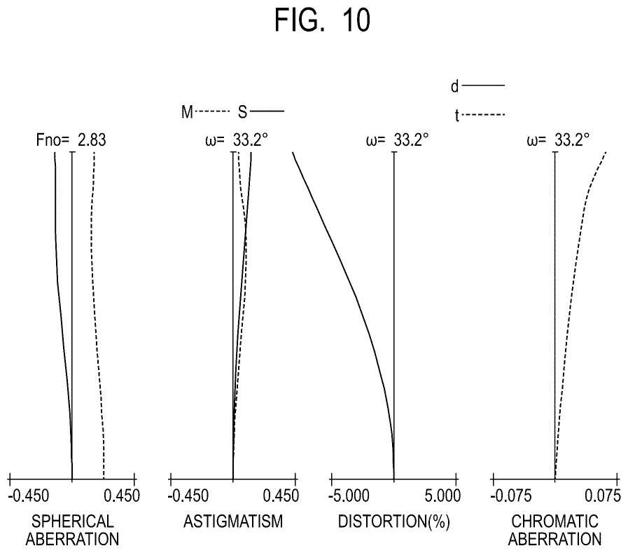

FIG. 10 is a longitudinal aberration diagram when focusing on an object at infinity at the wide angle end in a state where the rear converter lens Gr according to Embodiment 5 is disposed in the main lens Gm. In the longitudinal aberration diagram, a solid line and a broken line in the spherical aberration indicate the d-line and the t-line, respectively. A broken line and a solid line in the astigmatism indicate a meridional image plane and a sagittal image plane, respectively, and a one-dot chain line in the chromatic aberration of magnification indicates the t-line. ω is a half angle of view, and Fno is an F number. In the longitudinal aberration diagram, the spherical aberration, the astigmatism, the distortion, and the lateral chromatic aberration are drawn on scales of 0.45 mm, 0.45 mm, 5%, and 0.075 mm, respectively.

The rear converter lens Gr according to Embodiment 5 is a converter lens that is disposed on the image side of the main lens Gm to enlarge the focal length of the main lens Gm to 1.5 times.

The rear converter lens Gr includes seven lenses, i.e., a positive lens, a negative lens, a cemented lens formed by cementing the second positive lens Lp2 and the second negative lens Ln2, a cemented lens formed by cementing the first positive lens Lp1 and the first negative lens Ln1, and the third positive lens Lp3, in order from the object along the optical axis.

By configuring the rear converter lens Gr with four positive lenses and three negative lenses, it is possible to achieve the effect of correcting the chromatic aberration at the near-infrared light of the main lens Gm with the rear converter lens Gr by applying a material having an anomalous dispersion property of the partial dispersion ratio with respect to the C-line and the t-line to those lenses while achieving a configuration advantageous for correcting the spherical aberration at the visible light and the curvature of field.

As shown in the aberration diagram of FIG. 10, the rear converter lens Gr of Embodiment 5 satisfactorily corrects each aberration. As shown in Table 1, the rear converter lens Gr of Numerical Embodiment 5 corresponding to Embodiment 5 satisfies the inequalities (1) to (13) and realizes a rear converter lens that sufficiently corrects chromatic aberration at the near-infrared light of the main lens.

### Embodiment 6

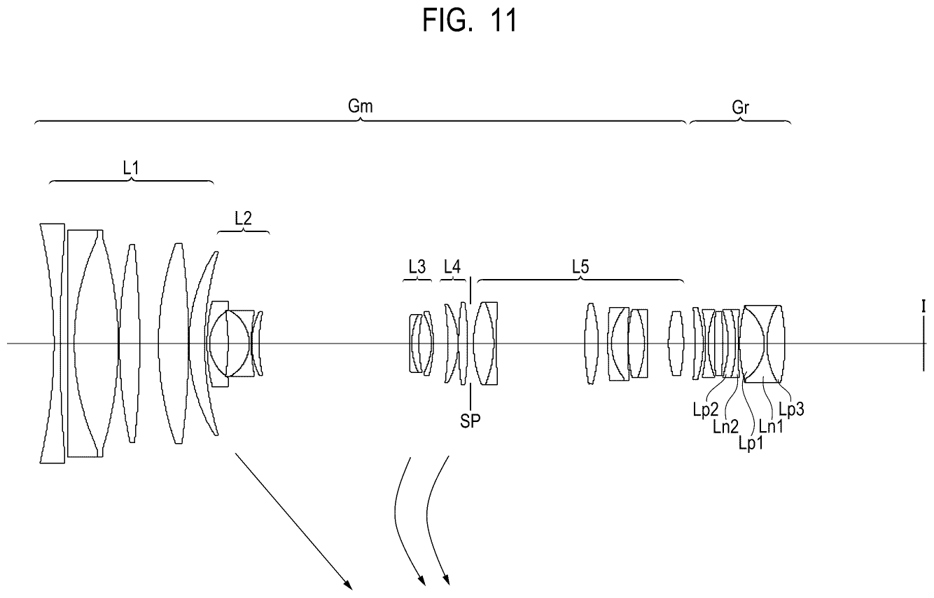

FIG. 11 is a diagram illustrating a configuration of an entire optical system in a state in which a rear converter lens Gr according to Embodiment 6 is disposed in a main lens Gm in a wide-angle end state.

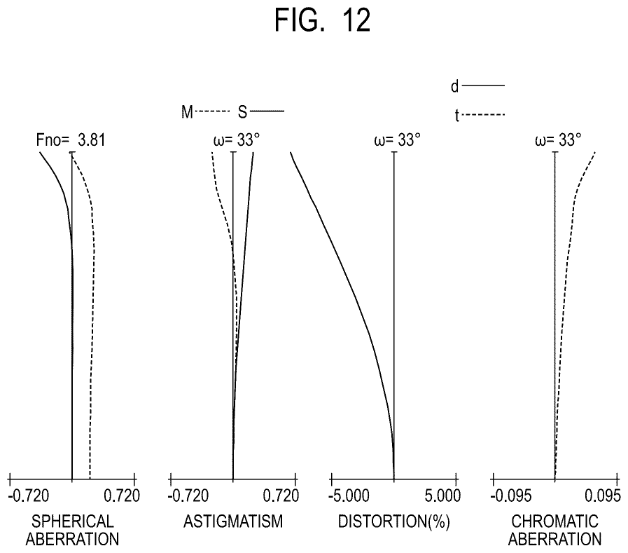

FIG. 12 is a longitudinal aberration diagram when focusing on an object at infinity at the wide angle end in a state where the rear converter lens Gr according to Embodiment 6 is disposed in the main lens Gm. In the longitudinal aberration diagram, a solid line and a broken line in the spherical aberration indicate the d-line and the t-line, respectively. A broken line and a solid line in the astigmatism indicates a meridional image plane and a sagittal image plane, respectively, and a one-dot chain line in the chromatic aberration of magnification indicates the t-line. ω is a half angle of view, and

Fno is an F number. In the longitudinal aberration diagram, the spherical aberration, the astigmatism, the distortion, and the lateral chromatic aberration are drawn on scales of 0.72 mm, 0.72 mm, 5%, and 0.095 mm, respectively.

The rear converter lens Gr according to Embodiment 6 is a converter lens which is disposed on the image side of the main lens Gm and thereby enlarges the focal length of the main lens Gm twice.

The rear converter lens Gr includes eight lenses, i.e., a positive lens, a negative lens, a positive lens, a cemented lens formed by cementing the second positive lens Lp2 and the second negative lens Ln2, and a cemented lenses formed by cementing the first positive lens Lp1, the first negative lens Ln1, and the third positive lens Lp3, in order from the object along the optical axis.

By configuring the rear converter lens Gr with five positive lenses and three negative lenses, it is possible to achieve the effect of correcting the chromatic aberration at the near-infrared light of the main lens Gm with the rear converter lens Gr by applying a material having an anomalous dispersion property of the partial dispersion ratio with respect to the C-line and the t-line to these lenses while achieving a configuration advantageous for correcting the spherical aberration at the visible light and the curvature of field.

As shown in the aberration diagrams of FIG. 12, the rear converter lens Gr of Embodiment 6 satisfactorily corrects each aberration. As shown in Table 1, the rear converter lens Gr of Numerical Embodiment 6 corresponding to Embodiment 6 satisfies the inequalities (1) to (13) and realizes a rear converter lens that sufficiently corrects chromatic aberration of near-infrared light of the main lens.

Next, numerical embodiments 1 to 6 corresponding to Embodiments 1 to 6 of the disclosure will be described. In each numerical embodiment, i represents the order of the surfaces from the object side, ri represents the radius of curvature of the i-th surface counted from the object side, di represents the distance between the i-th surface and the (i+1)-th surface from the object side, and ndi and vdi represent the refractive index and Abbe number of the optical member between the i-th surface and the (i+1)-th surface, respectively. The focal length, the F-number, and the angle of view each represent a value when focusing on an object at infinity. BF is a value obtained by converting the distance from the final surface of the lens to the image plane into an air-equivalent value.

In each embodiment, the main lens Gm is common, the first surface to the forty-first surface correspond to the main lens Gm, and the surfaces on the image plane side of the forty-first surface correspond to the rear converter lens Gr.

<Main Lens Gm>
Unit mm
Surface Data

| Surface number | r | d | nd | vd |
|---|---|---|---|---|
| 1 | −185.439 | 2.30 | 1.80100 | 35.0 |
| 2 | 486.543 | 2.84 | | |
| 3 | −98329.224 | 2.30 | 1.80100 | 35.0 |
| 4 | 91.150 | 16.10 | 1.49700 | 81.5 |
| 5 | −129.965 | 0.40 | | |
| 6 | 165.185 | 7.38 | 1.43387 | 95.1 |
| 7 | −347.780 | 6.90 | | |
| 8 | 109.329 | 10.97 | 1.61800 | 63.3 |
| 9 | −264.615 | 0.15 | | |
| 10 | 63.587 | 5.74 | 1.77250 | 49.6 |
| 11 | 114.104 | (variable) | | |
| 12 | 65.758 | 0.90 | 1.88300 | 40.8 |
| 13 | 14.444 | 6.74 | | |
| 14 | −76.887 | 7.75 | 1.80810 | 22.8 |
| 15 | −13.515 | 0.70 | 1.88300 | 40.8 |
| 16 | 56.355 | 0.20 | | |
| 17 | 25.182 | 2.72 | 1.67270 | 32.1 |
| 18 | 53.836 | (variable) | | |
| 19 | 290.152 | 0.75 | 1.77250 | 49.6 |
| 20 | 24.237 | 2.69 | 1.84666 | 23.8 |
| 21 | 51.848 | 4.44 | | |
| 22 | −21.958 | 0.75 | 1.77250 | 49.6 |
| 23 | −41.575 | (variable) | | |
| 24 | −97.365 | 3.75 | 1.63854 | 55.4 |
| 25 | −28.574 | 0.15 | | |
| 26 | 108.068 | 3.39 | 1.51633 | 64.1 |
| 27 | −100.494 | (variable) | | |
| 28(stop) | ∞ | 1.30 | | |
| 29 | 39.067 | 7.36 | 1.51742 | 52.4 |
| 30 | −38.220 | 0.90 | 1.83481 | 42.7 |
| 31 | 214.266 | 32.40 | | |
| 32 | 78.982 | 4.90 | 1.49700 | 81.5 |
| 33 | −51.551 | 3.48 | | |
| 34 | 156.842 | 1.40 | 1.83400 | 37.2 |
| 35 | 19.962 | 5.80 | 1.48749 | 70.2 |
| 36 | 127.749 | 0.20 | | |
| 37 | 52.200 | 5.90 | 1.51823 | 58.9 |
| 38 | −32.007 | 1.40 | 1.83481 | 42.7 |
| 39 | −361.712 | 7.50 | | |
| 40 | 44.409 | 5.35 | 1.50127 | 56.5 |
| 41 | −58.231 | 38.40 | | |
| Image plane | ∞ | | | |

Various Data
Zoom Ratio 21.98

| | wide angle | | Telephoto |
|---|---|---|---|
| | end | Middle | end |
| Focal length | 7.70 | 36.06 | 169.16 |
| F number | 1.90 | 1.90 | 2.80 |
| Half angle of view | 0.00 | 0.00 | 0.00 |
| Image height | 0.00 | 0.00 | 0.00 |
| Total lens length | 268.34 | 268.31 | 268.13 |
| BF | 38.40 | 38.40 | 38.40 |
| d11 | 0.89 | 36.86 | 51.88 |
| d18 | 54.99 | 6.83 | 7.98 |
| d23 | 5.30 | 10.60 | 1.15 |
| d27 | 0.81 | 7.71 | 1.00 |

Zoom lens group data

| | Leading | Focal |
|---|---|---|
| Unit | surface | length |
| 1 | 1 | 67.38 |
| 2 | 12 | −13.71 |
| 3 | 19 | −36.63 |
| 4 | 24 | 38.57 |
| 5 | 28 | 54.53 |

<Numerical Embodiment 1>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | −826.194 | 0.90 | 1.64000 | 60.1 | 0.8645 |
| 43 | 25.634 | 4.68 | | | |
| 44 | −58.642 | 4.10 | 1.55200 | 70.7 | 0.8096 |
| 45 | −25.244 | 0.90 | 1.64000 | 60.1 | 0.8645 |
| 46 | −316.776 | 0.60 | | | |
| 47 | 46.317 | 8.95 | 1.55200 | 70.7 | 0.8096 |
| 48 | −21.563 | 0.90 | 1.64000 | 60.1 | 0.8645 |
| 49 | −122.170 | 0.20 | | | |
| 50 | 85.954 | 4.48 | 1.69930 | 51.1 | 0.7593 |
| 51 | −76.002 | 38.07 | | | |
| Image plane | ∞ | | | | |

Various Data
Distance from the final surface
of the main lens Gm
d41 5.90

| | |
|---|---|
| Focal length | 10.07 |
| F number | 2.49 |
| Half angle of view | 32.84 |
| Image height | 6.50 |
| Total lens length | 299.58 |
| BF | 38.07 |

Focal length of rear converter lens Gr
289.09
Each of the rear converter lens Gr
single lens data

| | Leading | Focal |
|---|---|---|
| Lens | surface | length |
| 1 | 42 | −38.83 |
| 2 | 44 | 76.94 |
| 3 | 45 | −42.91 |
| 4 | 47 | 27.97 |
| 5 | 48 | −41.06 |
| 6 | 50 | 58.35 |

<Numerical Embodiment 2>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | −110.280 | 1.20 | 1.51633 | 64.1 | 0.8687 |
| 43 | 23.839 | 6.55 | | | |
| 44 | −348.990 | 9.66 | 1.55200 | 70.7 | 0.8096 |
| 45 | −17.068 | 1.20 | 1.51633 | 64.1 | 0.8687 |
| 46 | 147.386 | 0.20 | | | |
| 47 | 36.548 | 8.35 | 1.59522 | 67.7 | 0.7953 |
| 48 | −79.221 | 40.91 | | | |
| Image plane | ∞ | | | | |

Various Data
Distance from the final surface
of the main lens Gm
d41 2.89

| | |
|---|---|
| Focal length | 10.03 |
| F number | 2.48 |
| Half angle of view | 32.96 |
| Image height | 6.50 |
| Total lens length | 300.85 |
| BF | 40.91 |

Focal length of rear converter lens Gr
349.59
Each of the rear converter lens Gr
single lens data

| | Leading | Focal |
|---|---|---|
| Lens | surface | length |
| 1 | 42 | −37.85 |
| 2 | 44 | 32.18 |
| 3 | 45 | −29.55 |
| 4 | 47 | 43.18 |

<Numerical Embodiment 3>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | −87.388 | 0.90 | 1.64000 | 60.1 | 0.8645 |
| 43 | 25.967 | 1.79 | | | |
| 44 | 40.967 | 7.07 | 1.55200 | 70.7 | 0.8096 |
| 45 | −25.128 | 0.90 | 1.64000 | 60.1 | 0.8645 |
| 46 | 48.408 | 0.60 | | | |
| 47 | 32.116 | 9.72 | 1.59522 | 67.7 | 0.7953 |
| 48 | −18.627 | 0.90 | 1.64000 | 60.1 | 0.8645 |
| 49 | −41.436 | 0.20 | | | |
| 50 | 118.430 | 6.17 | 1.75106 | 43.1 | 0.7100 |
| 51 | ∞ | 23.24 | | | |
| Image plane | | | | | |

Various Data
Distance from the final surface
of the main lens Gm
d41 6.60

| | |
|---|---|
| Focal length | 7.87 |
| F number | 1.94 |
| Half angle of view | 32.44 |
| Image height | 5.00 |
| Total lens length | 287.99 |
| BF | 23.24 |

Focal length of rear converter lens Gr
104.16
Each of the rear converter lens Gr
single lens data

| | Leading | Focal |
|---|---|---|
| Lens | surface | length |
| 1 | 42 | −31.18 |
| 2 | 44 | 29.33 |
| 3 | 45 | −25.72 |
| 4 | 47 | 21.33 |
| 5 | 48 | −53.70 |
| 6 | 50 | 157.69 |

<Numerical Embodiment 4>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | −30.282 | 0.90 | 1.65160 | 58.5 | 0.8525 |
| 43 | 32.057 | 2.10 | | | |
| 44 | 36.476 | 6.79 | 1.43875 | 94.9 | 0.8373 |
| 45 | −24.088 | 0.00 | | | |
| 46 | 31.892 | 4.99 | 1.43875 | 94.9 | 0.8373 |
| 47 | −82.254 | 0.90 | 1.61340 | 44.3 | 0.7825 |
| 48 | 36.951 | 0.20 | | | |
| 49 | 29.488 | 6.20 | 1.75106 | 43.1 | 0.7100 |
| 50 | −381.032 | 20.09 | | | |
| Image plane | ∞ | | | | |

Various Data
Distance from the final surface
of the main lens Gm
d41 1.98

| | |
|---|---|
| Focal length | 5.45 |
| F number | 1.35 |
| Half angle of view | 32.70 |
| Image height | 3.50 |
| Total lens length | 274.05 |
| BF | 20.09 |

Focal length of rear converter lens Gr
47.59
Each of the rear converter lens Gr
single lens data

| | Leading | Focal |
|---|---|---|
| Lens | surface | length |
| 1 | 42 | −23.76 |
| 2 | 44 | 34.24 |
| 3 | 46 | 53.09 |
| 4 | 47 | −41.45 |
| 5 | 49 | 36.68 |

<Numerical Embodiment 5>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | 100.000 | 3.00 | 1.59522 | 67.7 | 0.7953 |
| 43 | −100.000 | 1.00 | | | |
| 44 | −79.769 | 0.90 | 1.64000 | 60.1 | 0.8645 |
| 45 | 23.972 | 4.33 | | | |
| 46 | −43.116 | 4.50 | 1.59522 | 67.7 | 0.7953 |
| 47 | −16.402 | 0.90 | 1.64000 | 60.1 | 0.8645 |
| 48 | 4049.304 | 0.60 | | | |
| 49 | 49.907 | 8.75 | 1.59522 | 67.7 | 0.7953 |
| 50 | −16.750 | 0.90 | 1.65160 | 58.5 | 0.8525 |
| 51 | 1583.415 | 0.20 | | | |
| 52 | 143.930 | 4.28 | 1.75106 | 43.1 | 0.7100 |
| 53 | −48.946 | 34.81 | | | |
| Image plane | ∞ | | | | |

Various Data
Distance from the final surface
of the main lens Gm
d41 6.62

| | |
|---|---|
| Focal length | 11.48 |
| F number | 2.83 |
| Half angle of view | 33.16 |
| Image height | 7.50 |
| Total lens length | 300.69 |
| BF | 34.81 |

Focal length of rear converter lens Gr
−687.30
Each of the rear converter lens Gr
single lens data

| | Leading | Focal |
|---|---|---|
| Lens | surface | length |
| 1 | 42 | 84.48 |
| 2 | 44 | −28.70 |
| 3 | 46 | 41.84 |
| 4 | 47 | −25.52 |
| 5 | 49 | 22.15 |
| 6 | 50 | −25.43 |
| 7 | 52 | 49.10 |

<Numerical Embodiment 6>
Unit mm
Surface Data

| | | | | | |
|---|---|---|---|---|---|
| Surface number | r | d | nd | vd | θct |

(1-41 Main lens unit Gm)

| | | | | | |
|---|---|---|---|---|---|
| 42 | −145.230 | 3.00 | 1.59522 | 67.7 | 0.7953 |
| 43 | −41.743 | 1.00 | | | |
| 44 | −56.676 | 0.90 | 1.64000 | 60.1 | 0.8645 |
| 45 | 32.090 | 2.28 | | | |
| 46 | 200.000 | 3.00 | 1.59522 | 67.7 | 0.7953 |
| 47 | −200.000 | 2.00 | | | |
| 48 | −38.006 | 2.72 | 1.52841 | 76.5 | 0.8175 |
| 49 | −46.587 | 0.90 | 1.64000 | 60.1 | 0.8645 |
| 50 | 173.871 | 0.60 | | | |
| 51 | 50.616 | 9.01 | 1.55200 | 70.7 | 0.8096 |
| 52 | −15.435 | 0.90 | 1.65160 | 58.5 | 0.8525 |
| 53 | 27.522 | 6.61 | 1.75106 | 43.1 | 0.7100 |
| 54 | −64.240 | 50.76 | | | |
| Image plane | ∞ | | | | |

Various Data
Distance from the final surface
of the main lens Gm
d41 4.20

| | |
|---|---|
| Focal length | 15.41 |
| F number | 3.81 |
| Half angle of view | 32.97 |
| Image height | 10.00 |
| Total lens length | 317.76 |
| BF | 50.76 |

Focal length of rear converter lens Gr
−94.08
Each of the rear converter lens Gr
single lens data

| | Leading | Focal |
|---|---|---|
| Lens | surface | length |
| 1 | 42 | 97.37 |
| 2 | 44 | −31.89 |
| 3 | 46 | 168.48 |
| 4 | 48 | −438.55 |
| 5 | 49 | −57.32 |
| 6 | 51 | 22.52 |
| 7 | 52 | −15.05 |
| 8 | 53 | 26.47 |

Table 1 shows values corresponding to the respective inequalities of the embodiments. The embodiments satisfy the inequalities (1) to (13) and realize the rear converter lens Gr in which the various aberrations are satisfactorily corrected.

TABLE 1
Corresponding values of each embodiment for inequalities

| | | Embodiment | Embodiment | Embodiment | Embodiment | Embodiment | Embodiment |
|---|---|---|---|---|---|---|---|
| Inequality | | 1 | 2 | 3 | 4 | 5 | 6 |
| (1) | Δθct_p1 | −0.0688 | −0.0688 | −0.0692 | −0.1548 | −0.0692 | −0.0688 |
| (2) | Δθct_p2 | −0.0688 | −0.0692 | −0.0688 | −0.1548 | −0.0692 | −0.0692 |
| (3) | Δθct_n1 | 0.0359 | 0.0211 | 0.0359 | 0.0281 | 0.0312 | 0.0312 |
| (4) | vp1 | 70.70 | 70.70 | 67.74 | 94.93 | 67.74 | 70.70 |
| (5) | vp2 | 70.70 | 67.74 | 70.70 | 94.93 | 67.74 | 67.74 |
| (6) | vn1 | 60.10 | 64.10 | 60.10 | 44.30 | 58.50 | 58.50 |
| (7) | Δθct_n2 | 0.0359 | 0.0211 | 0.0359 | 0.0312 | 0.0359 | 0.0359 |
| (8) | fp1/f\| | 0.0967 | 0.0920 | 0.2048 | 0.7195 | 0.0322 | 0.2394 |
| (9) | fp2/\|f\| | 0.2661 | 0.1235 | 0.2816 | 1.1156 | 0.0609 | 0.2394 |
| (10) | fn1/f\| | −0.1420 | −0.0845 | −0.2470 | −0.8710 | −0.0370 | −0.1600 |
| (11) | Δθct_p3 | −0.0271 | — | −0.0392 | −0.0392 | −0.0392 | −0.0392 |
| (12) | Np3 | 1.6993 | — | 1.7511 | 1.7511 | 1.7511 | 1.7511 |
| (13) | β | 1.3088 | 1.3028 | 1.0222 | 0.7083 | 1.4918 | 2.0031 |
| θct | (Lp1) | 0.8096 | 0.8096 | 0.7953 | 0.8373 | 0.7953 | 0.8096 |
| | (Lp2) | 0.8096 | 0.7953 | 0.8096 | 0.8373 | 0.7953 | 0.7953 |
| | (Lp3) | 0.7593 | — | 0.7100 | 0.7100 | 0.7100 | 0.7100 |
| | (Ln1) | 0.8645 | 0.8687 | 0.8645 | 0.7100 | 0.8525 | 0.8525 |
| | (Ln2) | 0.8645 | 0.8687 | 0.8645 | 0.8525 | 0.8645 | 0.8645 |
| vn | (Ln2) | 60.10 | 64.14 | 60.10 | 58.54 | 60.10 | 60.10 |
| vp | (Lp3) | 51.10 | — | 43.10 | 43.10 | 43.10 | 43.10 |

| | | | | | | |
|---|---|---|---|---|---|---|
| f | 289.090 | 349.592 | 104.163 | 47.586 | −687.299 | −94.076 |
| fp1 | 27.966 | 32.177 | 21.332 | 34.236 | 22.155 | 22.520 |
| fp2 | 76.937 | 43.180 | 29.332 | 53.088 | 41.840 | 22.520 |
| fn1 | −41.056 | −29.552 | −25.724 | −41.448 | −25.431 | −15.052 |

Although preferred embodiments of the disclosure have been described above, the disclosure is not limited to these embodiments, and various modifications and changes can be made within the scope of the gist of the disclosure.

The lens surface of the lens constituting the rear converter lens Gr of the disclosure may be a flat surface or an aspherical surface. When the lens surface is an aspherical surface, the aspherical surface may be any of an aspherical surface obtained by grinding, a glass mold aspherical surface obtained by molding glass into an aspherical shape using a mold, and a composite aspherical surface obtained by forming a resin provided on the glass surface into an aspherical shape. The lens surface may be a diffractive surface, and the lens may be a gradient index lens (GRIN lens) or a plastic lens.

In addition, an antireflection film having high transmittance in a wide wavelength range may be applied to the lens surface of the lens constituting the rear converter lens Gr of the disclosure. Accordingly, flare and ghost can be reduced, and high contrast optical performance can be achieved.

### (Image Pickup Device)

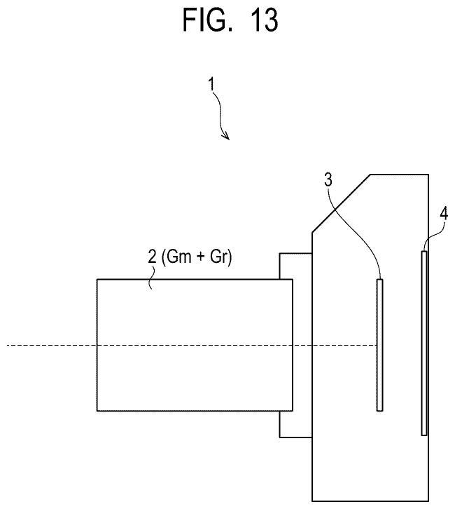

Next, an image pickup apparatus including the rear converter lens Gr of the disclosure will be described. FIG. 13 is a diagram illustrating a configuration of a camera including the rear converter lens Gr according to the disclosure. As shown in FIG. 13, the camera 1 is a camera of lens-interchangeable type including an image pickup lens 2. The image pickup lens 2 is configured as an optical system in which a rear converter lens Gr is disposed on the image side of the main lens Gm. For example, the image pickup lens 2 is configured such that a rear converter lens Gr is detachably attached to the image side of the main lens Gm.

In the camera 1, light from an object (subject) (not shown) is condensed by the image pickup lens 2 and forms a subject image on an image pickup surface of the image pickup unit 3 via an optical low-pass filter (not shown). Then, the subject image is photoelectrically converted by the photoelectric conversion element provided in the image pickup unit 3 to generate an image data of the subject. This image is displayed on an electronic viewfinder 4 provided in the camera 1.

Accordingly, the photographer can observe the subject through the electronic viewfinder 4, and when the release button (not shown) is pressed by the photographer, the image photoelectrically converted by the image pickup unit 3 is stored in the memory (not shown). In this way, the photographer can pick up an image of the subject by the camera 1. With the above configuration, the camera 1 including the rear converter lens Gr according to the disclosure can capture an image in which the chromatic aberration at the near-infrared light of the main lens Gm is sufficiently corrected.

According to the present disclosure, it is possible to provide a rear converter lens that sufficiently corrects the chromatic aberration at the near-infrared light of a main lens.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-232055, filed Dec. 27, 2024, which is hereby incorporated by reference herein in its entirety.

What is claimed is:

1. A rear converter lens disposed on an image side of a main lens, comprising a first positive lens, a second positive lens, and a first negative lens,
wherein the following inequalities are satisfied,
$$- 0.2 \leq Δθct\_p1 \leq - 0 \text{.02}$$
$$- 0.2 \leq Δθct\_p2 \leq - 0.02$$
$$0.017 \leq {Δθct}_{-} n 1 \leq 0.05$$
where Δθct_p1, Δθct_p2 and Δθct_n1 represent anomalous dispersion properties with respect to the C-line and the t-line of the first positive lens, the second positive lens and the first negative lens, respectively, and the anomalous dispersion property with respect to the C-line and the t-line Δθct is defined as
$$Δθ ct - θ ct - ( 0.0046925 \times v d + 0.5466489 )$$
where θct represents a partial dispersion ratio with respect to the C-line and the t-line and vd represents an Abbe number with respect to the d-line, and
wherein the following inequality is satisfied,
$$0.6 \leq β \leq 2.2$$
where β represents a ratio of a combined focal length of the main lens and the rear converter lens to a focal length of the main lens.

2. The rear converter lens according to claim 1, wherein the following inequality is satisfied,
$$50 \leq vp 1 \leq 100$$
$$50 \leq vp 2 \leq 100$$
where vp1 and vp2 represent Abbe numbers of the first positive lens and the second positive lens, respectively.

3. The rear converter lens according to claim 1, wherein the following inequality is satisfied,
$$30 \leq vn 1 \leq 80$$
where vn1 represents an Abbe number of the first negative lens.

4. The rear converter lens according to claim 1, further comprising a second negative lens,
wherein the following inequality is satisfied,
$$0.017 \leq Δθct\_n2 \leq 0.05$$
where Δθct_n2 represents an anomalous dispersion property with respect to the C-line and the t-line of the second negative lens.

5. The rear converter lens according to claim 1, wherein the following condition is satisfied,
$$0.02 \leq fp 1 / \vert f \vert \leq 0.8$$
where fp1 represents a focal length of the first positive lens and f represents a focal length of the rear converter lens.

6. The rear converter lens according to claim 4, wherein the following condition is satisfied,
$$0.05 \leq fp 2 / \vert f \vert \leq 1.2$$
where fp2 represents a focal length of the second positive lens and f represents a focal length of the rear converter lens.

7. The rear converter lens according to claim 1, wherein the following condition is satisfied,
$$- 0.9 \leq fn 1 / \vert f \vert \leq - 0.02$$
where fn1 represents a focal length of the first negative lens and f represents a focal length of the rear converter lens.

8. The rear converter lens according to claim 1, further comprising a third positive lens,
wherein the following condition is satisfied,
$$- 0.05 \leq Δθct\_p3 \leq - 0.02$$
$$1.6 \leq Np 3 \leq 1.8$$
where Δθct_p3 represents an anomalous dispersion property with respect to the C-line and the t-line of the third positive lens and Np3 represents a refractive index with respect to the d-line of the third positive lens.

9. The rear converter lens according to claim 1, wherein the first negative lens forms a cemented lens with at least one of the first positive lens and the second positive lens.

10. A rear converter lens disposed on an image side of a main lens, comprising a positive lens and a negative lens,
wherein the following inequalities are satisfied,
$$- 0.2 \leq Δθct\_p1 \leq - 0.02$$
$$0.017 \leq Δθct\_n1 \leq 0.05$$
where Δθct_p1 and Δθct_n1 represent anomalous dispersion properties with respect to the C-line and the t-line of the positive lens and the negative lens, respectively, and the anomalous dispersion property with respect to the C-line and the t-line Δθct is defined as
$$Δθ ct = θ ct - ( 0.0046925 \times vd + 0.5466489 )$$
where θct represents a partial dispersion ratio with respect to the C-line and the t-line and vd represents an Abbe number with respect to the d-line, and
wherein the following inequality is satisfied,
$$0.6 \leq β \leq 2.2$$
where β represents a ratio of a combined focal length of the main lens and the rear converter lens to a focal length of the main lens.

11. A lens apparatus, comprising a main lens and a rear converter lens detachably mounted on an image side of the main lens,
wherein the rear converter lens comprises a first positive lens, a second positive lens, and a first negative lens,
wherein the following inequalities are satisfied,
$$- 0.2 \leq Δθct\_p1 \leq - 0.02$$
$$- 0.2 \leq Δθct\_p2 \leq - 0.02$$
$$0.017 \leq Δθct\_n1 \leq 0.05$$
where Δθct_p1, Δθct_p2 and Δθct_n1 represent anomalous dispersion properties with respect to the C-line and the t-line of the first positive lens, the second positive lens and the first negative lens, respectively, and the anomalous dispersion property with respect to the C-line and the t-line Δθct is defined as
$$Δθ ct = θ ct - ( 0.0046925 \times vd + 0.5466489 )$$
where θct represents a partial dispersion ratio with respect to the C-line and the t-line and vd represents an Abbe number with respect to the d-line,
wherein the following inequality is satisfied,
$$0.6 \leq β \leq 2.2$$
where β represents a ratio of a combined focal length of the main lens and the rear converter lens to a focal length of the main lens.

12. An image pickup apparatus comprising a rear converter lens,
wherein the rear converter lens is disposed on an image side of a main lens,
wherein the rear converter lens comprises a first positive lens, a second positive lens, and a first negative lens,
wherein the following inequalities are satisfied,
$$- 0.2 \leq Δθct\_p1 \leq - 0.02$$
$$- 0.2 \leq Δθct\_p2 \leq - 0.02$$
$$0.017 \leq Δθct\_n1 \leq 0.05$$
where Δθct_p1, Δθct_p2 and Δθct_n1 represent anomalous dispersion properties with respect to the C-line and the t-line of the first positive lens, the second positive lens and the first negative lens, respectively, and the anomalous dispersion property with respect to the C-line and the t-line Δθct is defined as
$$Δθ ct = θ ct - ( 0.0046925 \times vd + 0.5466489 )$$
where θct represents a partial dispersion ratio with respect to the C-line and the t-line and vd represents an Abbe number with respect to the d-line, and
wherein the following inequality is satisfied,
$$0.6 \leq β \leq 2.2$$
where β represents a ratio of a combined focal length of the main lens and the rear converter lens to a focal length of the main lens.
